(19) United States
(12) Patent Application Publication
(10) Pub. No.: US 2011/0266223 A1
(43) Pub. Date: Nov. 3, 2011

(54) DUAL-LAYER HOLLOW FIBERS WITH ENHANCED FLUX AS FORWARD OSMOSIS MEMBRANES FOR WATER REUSES AND PROTEIN ENRICHMENT

(75) Inventors: Qian Yang, Singapore (SG); Kai Yu Wang, Singapore (SG); Tai-Shung Chung, Singapore (SG)

(73) Assignee: NATIONAL UNIVERSITY OF SINGAPORE

(21) Appl. No.: 13/124,274

(22) PCT Filed: Oct. 15, 2009
(86) PCT No.: PCT/US09/60791

§ 371 Date: Jul. 8, 2011

Related U.S. Application Data
(60) Provisional application No. 61/105,556, filed on Oct. 15, 2008.

(51) Int. Cl. C02F 1/44; B01D 67/00; B01D 61/00; B01D 71/42; B01D 71/68; B01D 71/56; B01D 71/52; B01D 63/02; B01D 71/64

(52) U.S. Cl. 210/651; 210/490; 264/171.12; 210/652

(57) ABSTRACT

A hollow fiber includes a lumen, a polymeric membrane defining the lumen, and a porous tubular substrate, a circumferential surface of which is in contact with a circumferential surface of the polymeric membrane. The polymeric membrane includes a first polymer having monomers each containing an imidazole group. The hollow fiber can be used for water reclamation and protein enrichment

### CROSS REFERENCE TO RELATED APPLICATIONS

This application claims the benefit of the priority of U.S. Provisional Application Ser. No. 61/105,556, filed Oct. 15, 2008, the content of which is incorporated herein by reference.

### FIELD OF THE INVENTION

The present invention relates to a dual-layer polybenzimidazole-polyethersulfone (PBI-PES) hollow fiber membrane in forward osmosis (FO) process for water reclamation. Another aspect of the invention proposes that FO process could be applied for the pharmaceutical products enrichment and concentration from the dilute media without denaturing the components of interest.

### BACKGROUND OF THE INVENTION

Forward (or direct) osmosis (FO), an emerging process for water reuses, desalination as well as for dewatering aqueous streams with very little energy consumption, has recently received growing attention from numerous disciplines, such as water reclamation, wastewater treatment, seawater desalination, concentration of liquid foods, the controlled release of drugs via osmotic pumps, power generation and water purification and reuse in space. See Wang et al., Journal of Membrane Science, 300 (2007) 6-12; Cath et al., Journal of Membrane Science, 281 (2006) 70-87; Holloway et al., Water Research, 41 (2007) 4005-4014; Cornelissen et al., Journal of Membrane Science, 319 (2008) 158-168; McCutcheon et al., Journal of Membrane Science, 278 (2006) 114-123; Miller et al., Tang et al., Desalination, 224 (2008) 143-153; Jiao et al., Journal of Food Engineering, 63 (2004) 303-324; Petrotos et al., Journal of Food Engineering, 49 (2001) 201-206; Dova et al., Journal of Food Engineering, 78 (2007) 422-430; Babu et al., Journal of Membrane Science, 280 (2006) 185-194; Sotthivirat et al., Journal of Pharmaceutical Sciences, 96 (2007) 2364-2374; Verma et al., Critical Reviews in Therapeutic Drug Carrier Systems, 21 (2004) 477-520; Seppala et al., Journal of Membrane Science, 161 (1999) 115-138; McGinnis et al., Journal of Membrane Science, 305 (2007) 13-19; Loeb, Desalination, 141 (2001) 85-91; Cath et al., Journal of Membrane Science, 257 (2005) 85-98; and Cath et al., Journal of Membrane Science, 257 (2005) 111-119.

Similar to reverse osmosis (RO), FO utilizes a selectively permeable membrane to separate water from dissolved solute molecules or ions. Nevertheless, instead of employing a hydraulic pressure as the driving force for the separation in the RO process, FO uses the chemical potential across the membrane, that is the osmotic pressure gradient, to induce a net flow of water through the membrane into the draw solution. Thus, FO may offer the advantages of high rejection of a wide range of contaminants and lower membrane-fouling propensities than traditional pressure-driven membrane processes. However, the major hurdles to fully explore FO potential as a new generation water production technology are 1) the limited number of commercially available FO membranes with superior separation performance; 2) the lack of desirable draw solutions which can be easily and directly separated from the extracted water with low energy expenditure; and 3) how to optimize the FO process to its theoretical efficiency. There is a need for developing new FO membranes with high water flux and high salt rejection properties.

### SUMMARY OF THE INVENTION

In one aspect, this invention relates to a hollow fiber, which includes a lumen, a polymeric membrane defining the lumen, and a porous tubular substrate, a circumferential surface of which is in contact with a circumferential surface of the polymeric membrane. The polymeric membrane includes a first polymer having monomers each containing an imidazole group.

In another aspect, the invention relates to a hollow fiber prepared by a method described herein. The method includes providing a first solution including a first solvent and a first polymer having monomers each containing an imidazole group, providing a second solution including a second solvent and a second polymer, and co-extruding the first and second solutions through a spinneret having at least two coaxial channels into a coagulation bath, thereby forming the hollow fiber having a lumen, a first tubular layer defining the lumen, and a second tubular layer, a circumferential surface of which is in contact with a circumferential surface of the first tubular layer. The first tubular layer contains the first polymer and the second tubular layer contains the second polymer and is porous.

Embodiments of the hollow fiber described above may include one or more of the following features.

The outer circumferential surface of the second tubular layer (e.g., the porous substrate) is in contact with the inner circumferential surface of the first tubular layer (e.g., the polymeric membrane containing the first polymer). The first polymer has bicyclic- or tri-cyclic heteroaryl monomers (i.e., repeating units) each containing an imidazole group such as benzimidazole. The second polymer included in the second tubular layer can be selected from the group consisting of polysulfone, a polyethersulfone, a polyarylate, a polyacrylnitrile, a polysulfide, a polyvinyl alcohol, a polyketone, a polyetherketone, a polyamide-imide, a polyimide, a polyamide, and a combination (e.g., a copolymer or polymer blend) thereof. The second layer may further include a polyvinylpyrrolidone (e.g., having molecular weight of 80-500 KDa or 150-360 KDa) blended with the second polymer. The first tubular layer (e.g., the polymeric membrane) has a thickness between 1 μm and 100 μm. The hollow fiber has a thickness between 100 μm and 1000 μm. The first polymer maybe the only polymer contained in the first tubular layer. The first layer may contain a third polymer that forms a polymer blend with the first polymer. The third polymer can be a polyimide, a polysulfone, a polyethersulfone, a polyarylate, polystyrene, a polyketone, a polyetherketone, or a polyamide-imide.

The co-extruding can be performed at a temperature between 20° C. and 100° C. (e.g., between 20° C. and 50° C.) and/or in a gaseous atmosphere (e.g., in air, nitrogen, argon, or other inert gases). The spinneret used for the co-extrusion preferable has the dimensions as shown in FIG. 2 (with three coaxial channels). The coagulation bath may have a temperature between 0° C. and 100° C. (e.g., between 20° C. and 50° C.). The coagulation bath and the spinneret can have an air gap between 0.5 cm and 100 cm (e.g., between 1 cm and 20 cm).

The term “air gap” refers the distance between the spinneret outlet and the top surface of the coagulation bath.

The term “heteroaryl” refers to a monovalent or bivalent aromatic 5-8 membered monocyclic, 8-12 membered bicyclic, or 11-14 membered tricyclic ring system having one or more heteroatoms (such as O, N, S, or Se).

Examples of polybenzimidazoles include, but are not limited to, poly-2,2′-(m-phenylene)-5,5′-bibenzimidazole (“PBI”), poly-2,2′-(pyridylene-3″,5″)-5,5′-bibenzimidazole, poly-2,2′-(furylene-2″,5″)-5,5′-bibenzimidazole, poly-2,2-(naphthalene-1″,6″)-5,5′-bibenzimidazole, poly-2,2′-(biphenylene-4″,4″)-5,5′-bibenzimidazole, poly-2,2′-amylene-5,5′-bibenzimidazole, poly-2,2′-octamethylene-5,5′-bibenzimidazole, poly-2,6-(m-phenylene)-diimidazobenzene, poly-2,2′-cyclohexenyl-5,5′-bibenzimidazole, poly-2,2′-(m-phenylene)-5,5′ di(benzimidazole)ether, poly-2,2′-(m-phenylene)-5,5′-di(benzimidazole)sulfide, poly-2,2′-(m-phenylene)-5,5′-di(benzimidazole)sulfone, poly-2,2′-(m-phenylene)-5,5′-di(benzimidazole)methane, poly-2′-2″-(m-phenylene)-5′,5″-(di(benzimidazole)propane-2,2, and poly-2′,2″-(m-phenylene)-5′,5″-di(benzimidazole)ethylene-1,2 where the double bonds of the ethylene are intact in the final polymer.

The term “polyimide” refers to both conventional and fluorinated polyimides. Examples of polyimides include, but are not limited to, Matirmid® 5218 (poly[3,3′4,4′-benzophenone tetracarboxylic dianhydride and 5(6)-amino-1-(4′-aminophenyl-1,3-trimethylindane)], or BTDA-DAPI), Torlon® 4000T, P84 (copolyimide of 3,3′4,4′-benzophenone tetracarboxylic dianhydride and 80% Methylphenylenediamine plus 20% methylenediamine), and polyimides containing hexafluoroisopropylidene (6FDA) groups, pyromellitic dianhydride (PMDA, Kapton), 1,4,5,8-Naphthalene tetracarboxylic dianhydride (NTDA), benzophenone tetracarboxylic dianhydride (BTDA), or 2,4,6-trimethyl-1,3-phenylene diamine, 3,3′,4,4′-biphenyltetracarboxylic dianhydride (BPDA).

In still another aspect, this invention relates to a method for extracting water from a saline solution through a forward osmosis process. The method includes contacting a first saline solution with the inner circumferential surface of the hollow fiber described above and contacting a second saline solution with the outer circumferential surface of the hollow fiber to allow one of the first and second saline solutions to extract water from the other through a forward osmosis process. The first and second saline solutions are separated by the hollow fiber, the first saline solution has a first water content, and the second saline solution has a second water content different from the first water content or the two solutions have different osmotic pressures.

Also within the scope of this invention is a method for enriching a protein in an aqueous solution through a forward osmosis process. The method includes contacting a first aqueous solution with the inner circumferential surface of the hollow fiber described above and contacting a second aqueous solution with the outer circumferential surface of the hollow fiber. The first and second aqueous solutions are separated by the hollow fiber. Of the two solutions, one contains the protein and has a lower osmotic pressure than the other. Upon contacting the opposite circumferential surfaces of the hollow fiber, the solution having a higher osmotic pressure than the protein-containing solution extracts water from it through a forward osmosis process, therefore enriching the protein (i.e., increasing the concentration of the protein in the solution).

The details of one or more embodiments of the invention are set forth in the description below. Other features, objects, and advantages of the invention will be apparent from the following drawings, detailed description of several embodiments, and also from the appending claims.

### BRIEF DESCRIPTION OF THE DRAWINGS

FIG. 1 shows the monomer structures of (A) polybenzimidazole (PBI) and (B) Polyethersulfone (PES).

FIG. 2 is a schematic diagram of a spinneret used for spinning a dual-layer hollow fiber.

FIG. 3 shows SEM images of PBI-PES dual-layer hollow fiber FO membrane.

FIGS. 4(A)-4(C) demonstrate (A) Solute separation; (B) probability density; and (C) cumulative pore size distribution curves for PBI-PES dual-layer hollow fiber FO membrane.

FIGS. 5(A) and 5(B) demonstrate the effect of draw solution concentration on (A) water and (B) salt flux (22.5° C.). In PRO mode, the draw solution was placed against the selective PBI outer-layer; in FO mode, the feed was placed against the selective PBI outer-layer.

FIGS. 6(A)-6(C) demonstrate use of a dual-layer hollow fiber forward osmosis membrane for protein enrichment: (A) Kinetics of water transportation through the membrane; (B) lysozyme concentration vs. time and (C) enrichment factor vs. time.

FIG. 7 shows the Circular Dichroism (CD) spectrum of lysozyme after FO enrichment test compared to that of the native lysozyme.

### DETAILED DESCRIPTION OF THE PREFERRED EMBODIMENTS

This invention is based in part on the unexpected discovery that certain dual-layer hollow fiber membranes have very high water flux and salt rejection properties, allowing them to be used as FO membranes.

It has been demonstrated that PBI nanofiltration (NF) hollow fiber membranes with a small pore size and a narrow pore size distribution can be used in the FO process for water reclamation. See Wang et al., Journal of Membrane Science, 300 (2007) 6-12. The self-charged characteristics of PBI and its superior hydrophilicity makes it less propensity for membrane fouling and provides great potential for water reuses. However, the water permeation flux of the aforementioned PBI NF hollow fiber membrane was not satisfactorily high. The maximum flux was around 11 L/(m²·hr) with 5M MgCl₂ as the draw solution. Without wishing to be bound by the theory, this was due to the effects of a thick dense PBI NF selective layer and a tight substructure. The latter was resulted from the high viscosity nature of PBI dopes and highly hydrophilic nature of PBI molecules.

Accordingly, one aspect of this invention relates to a synergetic combination of dual-layer membrane fabrication techniques and molecular engineering of polyethersulfone (PES)-polyvinylpyrrolidone (PVP) blends as the inner layer. As a result, the substructure resistance of PBI is substantially lowered while its high hydrophilicity is maintained. Dual-layer hollow fiber membranes have the advantage of maximizing membrane performance by using an extremely high-performance or functional membrane material as the selective layer, like PBI, and employing a low-cost material as the supporting layer, thus significantly reducing the overall membrane materials and production costs. See Jiang et al., Journal of Membrane Science, 252 (2005) 89-100; Li et al., Journal of Membrane Science, 277 (2006) 28-37; Li et al., Journal of Membrane Science, 243 (2004) 155-175; and Widjojo et al., Journal of Membrane Science, 294 (2007) 132-146.

To be applicable to water reuses, molecular engineering of the inner layer is essential so that it has a fully porous open-cell structure with substantial hydrophilicity. One suitable polymer for the inner layer is polyethersulfone (PES) for its tendency to form porous and open-cell structure with good mechanical properties. Polyvinylpyrrolidone (PVP) can be used to form a partial miscible polymer blend with PES to modify the hydrophobic nature of PES, thereby ensuring the inner layer with a stable hydrophilicity.

The dual-layer FO hollow fiber membranes of this invention, e.g., PBI-PES-PVP hollow fiber membranes, can be used not only for water production, but also for the enrichment of valuable proteins such as lysozyme. Accordingly, it is contemplated that the membranes of the invention can be used for the concentration of pharmaceutical products via dewatering but not by means of thermal treatment. Since most pharmaceutical products are labile and heat sensitive, nonthermal separation processes are preferred. Compared to the current extraction, distillation, and crystallization technologies for pharmaceutical enrichment, FO is a simpler, environmental friendlier and higher efficacy process.

The state-of-the-art for dual-layer membrane fabrication via co-extrusion technology utilized in this invention provides the membrane product with an ultra-thin selective dense skin, water channels underneath and microporous sponge-like support structure. Together with its sharp pore size distribution, the dual-layer hollow fiber forward osmosis membrane can achieve a water flux as high as 24.8 liter/(m² hr) without elevated operation temperatures and salt flux less than 1.0 g/(m² hr). The high rate of water flux and high salt rejection is contributed by the desirable dual-layer membrane structure via appropriate membrane fabrication technique. A comprehensive literature review of previous efforts on identifying suitable membranes and appropriate draw solutions in FO process shows that the water flux of the dual-layer hollow fiber FO membrane developed in this disclosure generally surpasses those FO processes utilizing RO membranes and is comparable or even better than most FO processes using commercial FO membranes.

In addition, the FO membranes of this invention can be applied to pharmaceutical products enrichment and concentration from the dilute media. A typical example demonstrated in this disclosure is to enrich lysozyme protein enzyme solution by the dual-layer forward osmosis membrane using MgCl₂ as the draw solution. It shows that the diluted lysozyme can be enriched by a factor of 3.5 in three hours using a membrane module with effective area 83.2 cm² only. The favorably less protein fouling behavior is identified in the enrichment process when feed protein flows against highly hydrophilic PBI outer-layer. The low salt flux of this dual-layer membrane ensures the enriched protein product without conformation change and denaturing.

Without further elaboration, it is believed that the above description has adequately enabled the present invention. The following examples are, therefore, to be construed as merely illustrative, and not limitative of the remainder of the disclosure in any way whatsoever. All of the publications cited herein are hereby incorporated by reference in their entirety.

### EXAMPLES

### A. Materials

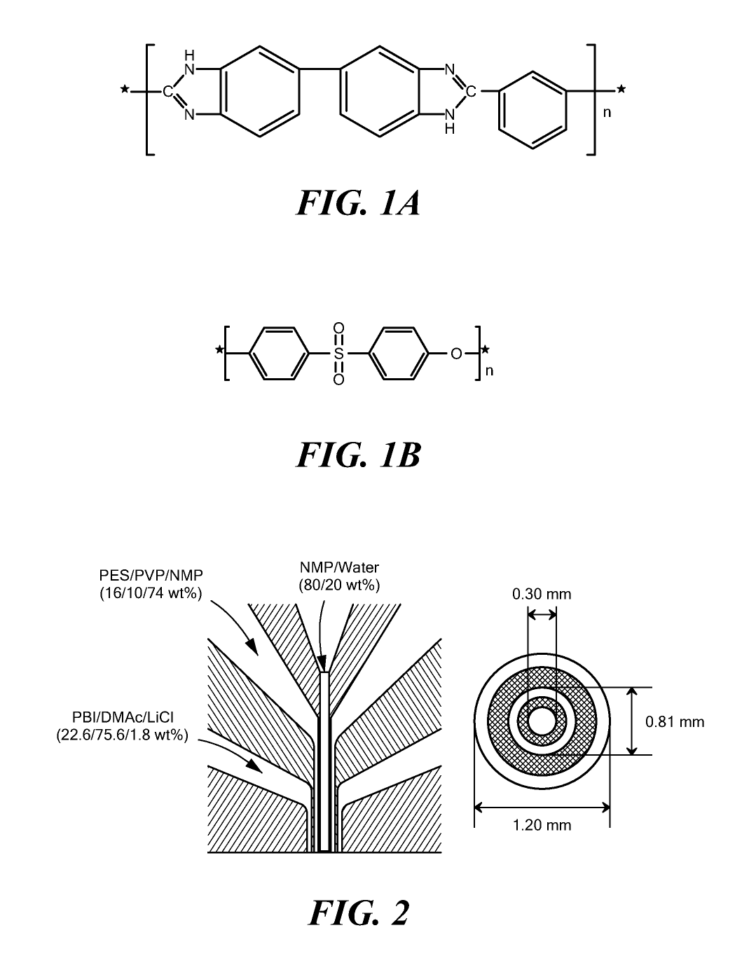

The polybenzimidazole (PBI) dope was purchased from PBI Performance Products Inc., (NC, USA) with a composition of PBI 25.6 wt %, N-Dimethylacetimide (DMAc) 72.4 wt % and LiCl 2.0 wt %. Polyethersulfone (PES, Udel A-300) was purchased from Amoco Company, USA. FIG. 1 shows the monomer chemical structures of PBI and PES materials. N-methyl-2-pyrrolidone (NMP) & DMAc (Merck, Singapore) as the solvents and polyvinylpyrrolidone (PVP, Mw 360 KDa) (Merck, Singapore) as an additive were employed for dual-layer hollow fiber membrane spinning Sodium hypochlorite (NaOCl) (Acros Organics, Singapore) was used as the post-treatment agent to remove unblended PVP in membrane's inner-layer. MgCl₂ supplied by Alfa Aesar (MA, USA) was dissolved in deionized water at various concentrations and used as the draw solutions. Neutral solutes of glycerol, glucose, saccharose and raffinose from Aldrich, USA were used for characterizing membrane pore size and pore size distributions. Molecular weights, diffusivities and Stokes radii of neutral solutes were listed in Wang et al., Journal of Membrane Science, 300 (2007) 6-12. Lysozyme supplied by Aldrich, USA was used as a model protein enzyme solution to be concentrated and enriched by FO process.

### B. Fabrication and Characterizations of PBI-PES Dual-Layer Hollow Fiber Membranes

The detailed schematic diagram of the hollow fiber spinning system has been described in Li et al., Journal of Membrane Science, 243 (2004) 155-175. Table I below lists the detailed spinning conditions.

TABLE 1
Spinning conditions of PBI-PES/PVP dual-layer hollow fiber membrane

| External dope solution (wt %) | PBI DM [symbol] LiCl (22.6 75.6 1.8) |
|---|---|
| External dope flow rate (ml min) | 0.5 |
| Inner dop [symbol] solution (wt %) | PES PVP XMP (16 10 74) |
| Inner do [symbol] flow rate (ml min) | 3 |
| Bone fl [symbol] composition (wt %) | XMP water (90 10) |
| Bone flow rate (ml min) | 1 |
| Length of air g [symbol] p (cm) | 10 |
| External coagulant, Temperature (° C.) | Tap Water: 26 ± 1 |
| Dope and bone fl [symbol] temperature (° C.) | 26 ± 1 |
| Spinning humidity (%) | 60 70% |
| Dimension of spin [symbol] et (mm) | OD₁ OD₂ ID (1.20 0.81 0.30) |
| Take up speed (m min) | 14 |

[symbol]

indicates data missing or illegible when filed

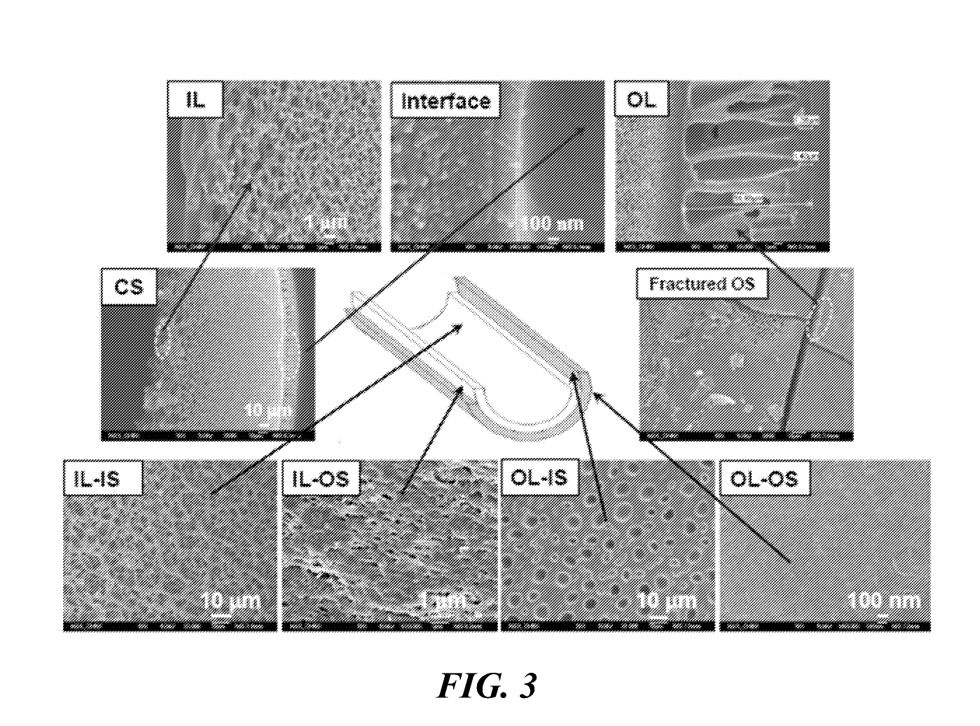

The dual-layer spinneret used in the Examples is shown in FIG. 2. The as-spun fibers were immersed in tap water for 3 days to remove any solvent residues. To remove unblended PVP and also increase the porosity and pore size in the membrane's inner-layer, the fibers were soaked in 8000 ppm NaOCl under stirring for 24 hrs. After that the hollow fiber membranes were further soaked in a 50 wt % glycerol solution for 48 hrs under stirring. After thoroughly air drying these membranes at room temperature, 20 pieces of hollow fibers with a length around 20 cm each were bundled into a Φ⅜ inch PFA tubing (Swagelok, USA) and two ends were sealed with epoxy resin to assemble a membrane module.

The morphology of the dual-layer hollow fiber membrane was observed under a field emission scanning microscopy (FESEM, JEOL JSM-6700). The detailed SEM specimen preparation was also described in Li et al., Journal of Membrane Science, 243 (2004) 155-175. The observations of dual-layer membrane's cross-section (CS), inner-layer (IL), inner-layer's inner surface (IL-IS), inner-layer's outer surface (IL-OS), outer-layer (OL), outer-layer's inner surface (OL-IS), outer-layer's outer surface (OL-OS) and also the fractured outer surface were conducted.

The hydrophobicity-hydrophilicity of the dual-layer hollow fiber membrane was characterized by contact angle measurements. A tensiometer (Sigma 701, KSV Instruments, Finland) was used to measure the contact angle of the hollow fiber membrane's outer-layer. Furthermore, in order to estimate the contact angle of the PES inner-layer within the dual-layer hollow fiber membrane, a flat sheet membrane was cast out with the same dope solution used for the inner-layer and immersed in a coagulant with the same composition as the fiber bore fluid. After soaked in 8000 ppm NaOCl for 24 hrs, the bleached flat sheet membrane was tested for contact angle measurements by a goniometer (FTÅ125, First Ten Ångstroms, USA) based on the sessile drop method at room temperature. It has been proved that the measured contact angles of flat sheets can give a reliable estimation for hollow fibers spun from the same material. See Bonyadi et al., Journal of Membrane Science, 306 (2007) 134-146. The same procedure was performed on a cast PBI flat sheet membrane for a comparison of contact angle measured by the tensiometer for the outer PBI layer.

### C. Membrane Characterization Through Nanofiltration Experiment

The assembled membrane module holding 20 pieces of PBI-PES dual-layer hollow fiber membranes was firstly subjected to the measurement of pure water permeability (PWP) flux in L/(m²·hr) (abbreviated as LMH thereafter) by an NF membrane setup (as described in Wang et al., AIChE Journal, 52 (2006) 1363-1377) but always operated at a normal pressure (1 bar) in Examples. Subsequently, the membrane module was subjected to neutral solute and salts separation tests with different feed solutions flowing through the membrane's selective outer-layer. Permeate was collected from the lumen side of the membrane module. The concentrations of the neutral solute in solutions were measured with a total organic carbon analyzer (TOC ASI-5000A, Shimadzu, Japan). The single salt concentration was measured with an electric conductivity meter (Lab 960, Schott, Germany). The measured feed (C_{f}) and permeate (Cₚ) concentrations were used for calculating the effective solute rejection coefficient R (%):

$$R = ( 1 - \frac{{C}_{p}}{{C}_{f}} ) \times 100 \% \qquad ( 1 )$$

### See Wang et al., Journal of Membrane Science, 300 (2007) 6-12; Wang et al., AIChE Journal, 52 (2006) 1363-1377; and Yang et al., Journal of Membrane Science, 313 (2008) 190-198.

In Examples, 200 ppm solutions containing glycerol, glucose, saccharose or raffinose were used as the neutral solute for membrane pore size and pore size distribution characterization. The relationship between Stokes radius (rₛ, m) and molecular weight (MW, g mol⁻¹) of these neutral solutes can be expressed as:

log rₛ=−1.4962+0.4567 log MW (2)

From Eq. (2), the radius (rₛ) of a hypothetical solute at a given MW can be obtained. The mean effective pore size and the pore size distribution were then obtained according to the traditional solute transport approach (as described in Wang et al., Journal of Membrane Science, 300 (2007) 6-12; Michaels, Separation Science and Technology, 15 (1980) 1305-1322; Youm et al., Journal of Chemical Engineering of Japan, 24 (1991) 1-7; and Singh et al., Journal of Membrane Science, 142 (1998) 111-127): by ignoring influences of the steric and hydrodynamic interaction between solute and membrane pores, the mean effective pore radius (μₚ) and the geometric standard deviation (σₚ) can be assumed to be the same as μₛ (the geometric mean radius of solute at R=50%) and σ_{g} (the geometric standard deviation defined as the ratio of the rs at R=84.13% over that at R=50%). Therefore, based on μₚ and σₚ, the pore size distribution of a membrane can be expressed as the following probability density function:

$$\frac{d R ( {r}_{p} )}{d {r}_{p}} = \frac{1}{{r}_{p} ln {σ}_{p} \sqrt{2 π}} exp [ - \frac{{( ln {r}_{p} - ln {μ}_{p} )}^{2}}{2 {( ln {σ}_{p} )}^{2}} ] \qquad ( 3 )$$

### D. Water Reclamation Through Forward Osmosis Tests

Forward osmosis tests on the membrane module with an effective membrane surface (external surface) area of 83.2 cm² were conducted on a lab-scale setup described in Wang et al., Journal of Membrane Science, 300 (2007) 6-12. The draw solutions of MgCl₂ at different concentrations and feed deionized water were counter-currently pumped through the module by two peristaltic pumps (Easy-load® 7518-10, Cole Parmer, USA). The draw solution was passed the membrane module once-through, whereas feed water circulated in the other side. The volumetric flow rates in the membrane module's lumen and shell were fixed both at 100 ml/min (corresponding to a linear velocity of 1.26 m/s in lumen and 6.03 cm/s in shell, respectively). Two different membrane orientations were tested to investigate the effect of membrane structure and concentration polarization on water permeation flux: 1) the pressure retarded osmosis (PRO) mode for when the draw solution flows against the selective layer (PBI outer-layer in this work), and 2) the forward osmosis (FO) mode for when the draw solution flows against the porous support layer (PES inner-layer in this work). A balance (EK-4100i, A & D Company Ltd., Japan) connected to a computer recorded down the mass of water permeating into the draw solution over a selected period of time.

The product water flux (J_{w}) was calculated from the slope of the feed weight change divided by the effective membrane area (A).

$${J}_{w} = \frac{Δ m}{Δ t} \frac{1}{A} \qquad ( 4 )$$

where Δm (kg) is the permeation water weight collected over a predetermined time Δt (hr) of FO process duration; where A is the effective membrane surface (based on the external diameter of hollow fibers).

The salt concentration in the feed water was determined from the conductivity measurement using a calibration curve for the single salt solution. The back-flow salt flux (Jₛ in g/(m²·hr), abbreviated as gMH) was thereafter determined from the increase of the feed conductivity:

$${J}_{s} = \frac{Δ ( {C}_{t} {V}_{t} )}{Δ t} \frac{1}{A} \qquad ( 5 )$$

where Cₜ and Vₜ are the salt concentration and the volume of the feed in the end of FO tests, respectively.

### E. Protein Enrichment Through Forward Osmosis Test

400 mL feed protein model solution (native lysozyme dissolved in deionized water at a concentration of 0.1 g/L and pH ˜4) was circulated through the shell while 800 mL draw solution (3.125M MgCl₂) recycling in the lumen of the membrane module. The lysozyme concentrations in the feed and draw solution were measured every half an hour by a UV-VIS scanning spectrophotometer (Libra S32, Biochrom Ltd., England) at a wavelength of 280 nm. The product water flux and salt flux were also recorded. The Circular Dichroism (CD) spectra of the native lysozyme solution at 0.4 g/L (pH ˜4.0) and the concentrated lysozyme solution after the FO enrichment test were investigated. The α-helix content of proteins estimated below was used to study the protein conformational changes, if any, after FO process.

$$\% α \text{-} Helix content = \frac{{θ}_{mrd}^{208} - 4000}{33000 - 4000} \qquad ( 6 )$$

where θ_{mrd}²⁰⁸ (deg cm²/dmol) is the mean molar ellipticity per residue at 208 nm. See Greenfield et al., Biochemistry, 8 (1969) 4104-4108.

### Example 1

### Morphologies of the PBI-PES-PVP Dual-Layer Hollow Fiber Membrane

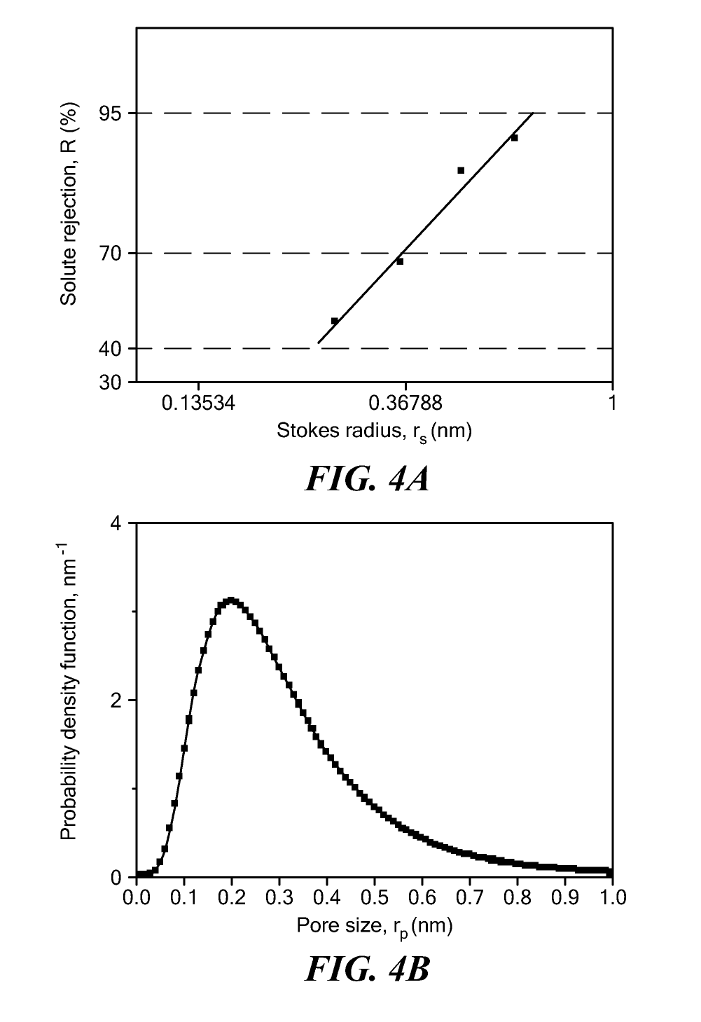

The as-made dual-layer membrane had outer and inner diameters of 522 and 290 μm, respectively (SEM images not shown here). FIG. 3 shows the cross-section (CS) morphology that consists of a PBI selective outer layer (OL) of around 20 μm, a fully porous sponge-like PES inner layer (IL), and a delamination-free interface. Underneath the PBI selective layer, there were plenty of macrovoids directly and openly connected to the interface as shown in the OL-IS section of FIG. 3, while the outer skin of the inner layer was porous as shown in the IL-OS section. As a result, there was no much resistance at the interface. Since the inner layer and inner layer surface were fully porous as shown in their corresponding IL and IL-IS photos, the PBI outer layer was the resistance and selective layer. However, as displayed in its OL photo, the average thickness of the selective layer was only about 2.04-2.23 μm if deducting the macrovoid length from the overall outer layer thickness. As a consequence, water can rapidly diffuse across the ultra-thin selective layer by the osmotic pressure.

Compared to the previous single-layer PBI hollow fibers made by Wang et al., Journal of Membrane Science, 300 (2007) 6-12, the uniqueness of the PBI-PES-PVP dual-layer hollow fiber membranes is that not only it possesses the sub-nano PBI pores in the outer-most surface for water passage and ion rejection, but also has a sponge-like open-cell PES inner layer with the aid of the PVP pore forming agent and the delayed demixing by the solvent-enriched bore fluid (80 wt % NMP). The combination of a highly hydrophilic PBI selective layer with sub-nano pores and a fully porous and hydrophilic substructure makes it easy for water permeation with a high transmembrane flux.

### Example 2

### Solute Rejections on the PBI-PES-PVP Dual-Layer Hollow Fiber Membrane

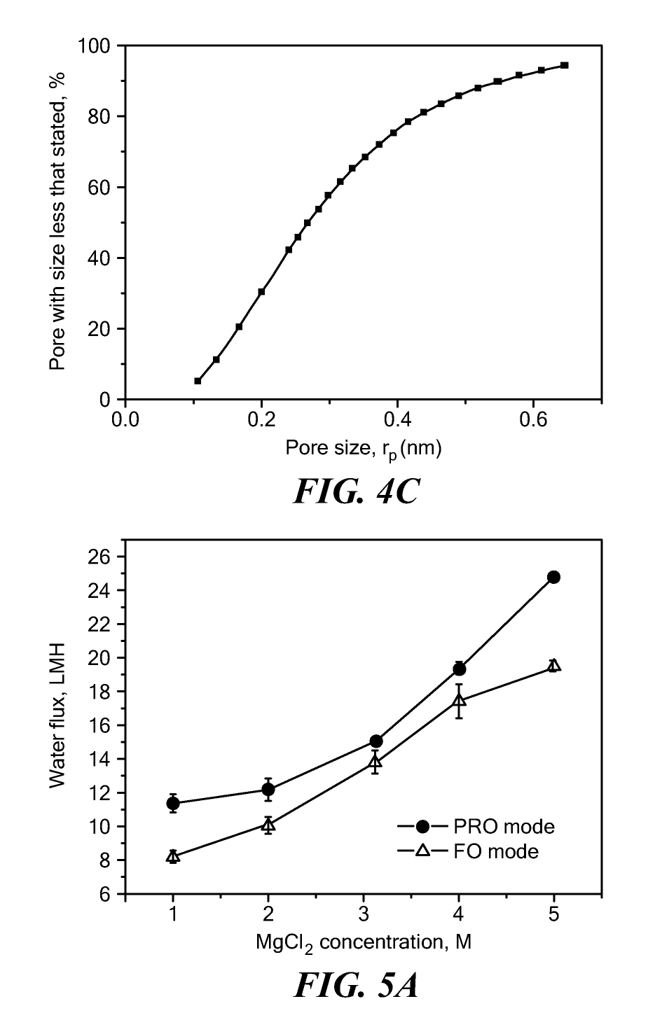

FIGS. 4(A)-(C) show the solute separation, probability density, and cumulative pore size distribution curves. Table II below summarizes the solute rejection results on the dual-layer hollow fiber forward osmosis membrane.

TABLE II
Solute rejection characterization results on PBI-PES dual-layer
membranes

| | | | PWP, LMH | NaCl | MgCl₂ |
|---|---|---|---|---|---|
| μ_{P}, nm | σ_{P} | MWCO, Da | (@ 1 bar) | rejection, % | rejection, % |
| 0.27 | 1.74 | 452 | 0.9 | 33.0 | 92.8 |

The average pore size (μₚ) of 0.27 nm in radius indicates the membrane achieved in Examples is sitting between the nanofiltration membrane and the reverse osmosis membrane. The pure water permeability (PWP) of this membrane was only 0.9 LMH at an operation pressure of one bar. The pore size distribution or the probability density curve shown in FIG. 4(B) indicates that the dual-layer hollow fiber membrane has a sharp pore size distribution. This is essential for rejecting ions and contaminants. Additional characterizations reveal that it exhibits a high rejection rate of 93% to divalent MgCl₂ salt while a low rejection rate of 33% to monovalent NaCl salt. The discrepancy in rejection for divalent and monovalent ions is mostly attributed to the ion size exclusion and Donnan electrostatic effect (see Donnan, Journal of Membrane Science, 100 (1995) 45-55). The salts rejection data indicate the dual-layer membrane is promising for FO application on water reclamation using MgCl₂ as the draw solution, while it is not suitable for sea water and salty water desalination since its NaCl rejection is quite low.

### Example 3

### Water Reclamation Via the PBI-PES-PVP Dual-Layer Hollow Fiber Membrane

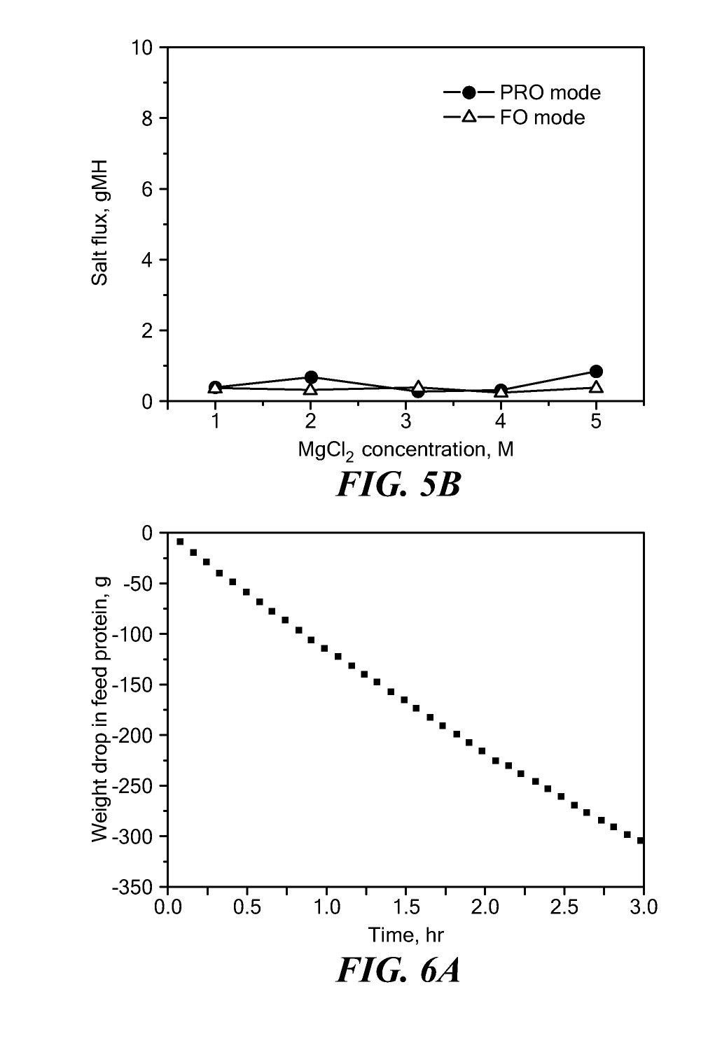

The dependence of water and salt flux on MgCl₂ concentration at two different operation modes, namely FO and PRO, is plotted in FIG. 5. It demonstrates that the water flux went up with an increased draw MgCl₂ concentration while the salt fluxes were satisfactorily low in any circumstance. Generally the water flux was five orders of magnitude higher than the salt flux with the correspondingly same draw solution used in FO tests. It is expected that the water flux increase with increased draw solution concentration is mostly due to the increased osmotic pressure as the driving force in both operation modes. In addition, the water permeation flux in PRO mode was much higher than that in FO mode. This is because in the FO mode the net driving force reduced more significantly than in the PRO mode due to the severe dilutive internal concentration polarization occurred in the porous support layer (i.e. in the PES-PVP inner layer in our case). See Wang et al., Journal of Membrane Science, 300 (2007) 6-12; Cath et al., Journal of Membrane Science, 281 (2006) 70-87; Ng et al., Environmental Science & Technology, 40 (2006) 2408-2413; McCutcheon et al., Journal of Membrane Science, 284 (2006) 237-247; and Gray et al., Desalination, 197 (2006) 1-8.

Table III below shows a performance comparison of the recent studies on FO membranes. So far, tremendous efforts have been devoted by researchers in this field to identify suitable membranes and appropriate draw solutions in the FO process in order to achieve a high water flux and high salt rejection. Generally various salts or sugar solutions have been used since they are highly soluble in water and have low molecular weights, resulting in high osmotic pressures. In addition, the separation and recovery of these draw solutions can be achieved easily by precipitation, heat decomposition or RO process.

TABLE III
Overview of recent researches on FO process with different membranes

| Operation | | | | | Draw | | Operation | | Flux | |
|---|---|---|---|---|---|---|---|---|---|---|
| Temp (° C.) | Feed | | Draw | | flow rate | | mode | Membrane | (LMH) | Ref. |
| 23 | DI water | | 5M | MgCl2 | 6.03 | cm/s | PRO | Dual-layer (PBI-PES) NF membrane | 24.78 | This work |
| 23 | DI water | | 5M | MgCl2 | 0.63 | m/s | FO | Dual-layer (PBI-PES) NF membrane | 19.47 | This work |
| 22.5 | DI water | | 5M | MgCl₂ | 0.56 | cm/s | PRO | PBI hollow fiber membrane | 11.0 | [1] |
| 67.0 | 3.5% | NaCl | 45% | Na₂HPO₄ | — | | — | RO membrane (AG), GE Osmonics | 2.5 | [6] |
| 67.0 | 3.5% | NaCl | 45% | Na₂HPO₄ | — | | — | RO membrane (AD), GE Osmonics | 1.1 | [6] |
| 69.0 | 3.5% | NaCl | 45% | Na₂HPO₄ | — | | — | Gore-Tex ® PTFE membrane, Gore | 4.1 | [6] |
| 69.0 | 3.5% | NaCl | 45% | Na₂HPO₄ | 36 | L/hr | PRO | Cellulose triacetate RO membrane, | 14.5 | [6] |
| | | | | | | | | Osmotek | (degraded | |
| | | | | | | | | | at pH 9) | |
| Ambient | water | | 98 g/L Anonymons | | — | | — | FO membrane, Hydration Technologies | 24.0 | [17] |
| temp. | | | osmotic agent | | | | | | | |
| 50.0 | 0.5M | NaCl | 4M | NH₄HCO₃ | 4.17 | cm/s | PRO | FO membrane, Hydration Technologies | 11.0 | [31] |
| 22.5 | DI water | | 0.5M | NaCl | 30 | cm/s | PRO | FO membrane, Hydration Technologies | 18.6 | [33] |
| 50.0 | 0.05M | NaCl | 6M | NH₄HCO₃ | 30 | cm/s | PRO | FO membrane, Hydration Technologies | 36.0 | [5] |
| 25.0 | Digester | | 70 g/L | NaCl | 1.5 | L/min | FO | FO membrane, Hydration Technologies | 16.4 | [3] |
| | centrate | | | | | | | | | |
| 50.0 | 0.5M | NaCl | 5M | Fructose | 8.34 | cm/s | PRO | FO membrane, Hydration Technologies | 19.5 | [7] |

| | | | | | | | | | |
|---|---|---|---|---|---|---|---|---|---|
| 20.0 | DI water | 0.5M | NaCl | 5.5 | L/min | FO | FO membrane, Hydration Technologies | 8.50 | [4] |
| 20.0 | Activated | 4.5M | NaCl | 5.5 | L/min | FO | FO membrane, Hydration Technologies | 12.9 | [4] |
| | sludge | | | | | | | | |
| 20.0 | DI | 1.5M | NaCl | 21.3 | cm/s | PRO | Polysulfone RO membrane with the | 8.1 | [34] |
| | | | | | | | fabric removed, Dow Filmtec | | |
| 20.0 | DI water | 1.5M | NaCl | 21.3 | cm/s | PRO | Cellulosic RO membrane with the | 36.0 | [34] |
| | | | | | | | fabric removed, GE Osmonics | | |
| 20.0 | DI water | 1.5M | NaCl | 21.3 | cm/s | PRO | FO membrane, Hydration Technologies | 43.2 | [32, 34] |

[1] K. Y. Wang et al., Journal of Membrane Science, 300 (2007) 6-12.
[3] Holloway et al., Water Research, 41 (2007) 4005-4014.
[4] Cornelissen et al., Journal of Membrane Science, 319 (2008) 158-168.
[5] McCutcheon et al., Journal of Membrane Science, 278 (2006) 114-123.
[6] Miller et al., Forward Osmosis: A New Approach to Water Purification and Desalination. 2006, Sandia National Laboratories.
[7] Tang et al., Desalination, 224 (2008) 143-153.
[17] Cath et al., Journal of Membrane Science, 257 (2005) 85-98.
[31] Ng et al., Environmental Science & Technology, 40 (2006) 2408-2413.
[32] McCutcheon et al., Journal of Membrane Science, 284 (2006) 237-247.
[33] Gray et al., Desalination, 197 (2006) 1-8.
[34] McCutcheon et al., Journal of Membrane Science, 318 (2008) 458-466.

It can be seen that the most common approach to select membranes for the FO process is simply to use RO membranes. Nevertheless, the main drawback of this practice is the limited flux achieved. It is less than 10 LMH in most FO processes for seawater desalination since the RO membranes are relatively thick by necessity to withstand the hydraulic pressure. It was reported recently by peeling off the support fabric from the RO membrane for FO tests, the flux of this RO membrane without fabric could increase dramatically from several LMH to 36 LMH (McCutcheon et al., Journal of Membrane Science, 318 (2008) 458-466). Although the strategy is promising for flux enhancement, the practice is not feasible in large scale membrane preparations for the FO process.

Hydration Technologies Inc. (HTI, previously Osmotek Inc.) is the market leader in membrane fabrications for the FO process. It has substituted the fabric support in the traditional RO membrane by an embedded polyester mesh and developed a specific FO membrane with a maximized water flux while maintaining the desired salt rejection. The membrane thickness is less than 50 μm and this membrane has been widely tested in water reclamation in space (Cath et al., Journal of Membrane Science, 257 (2005) 85-98; and Cath et al., Journal of Membrane Science, 257 (2005) 111-119), osmotic membrane bioreactor for water recovery (Cornelissen et al., Journal of Membrane Science, 319 (2008) 158-168), power generation (see McGinnis et al., Journal of Membrane Science, 305 (2007) 13-19) and seawater desalination (see McCutcheon et al., Desalination, 174 (2005) 1-11). Recent work conducted in Elimelech's research group demonstrates when water was used as the feed and 1.5 M NaCl as the draw solution, the flux can reach above 40 LMH (see McCutcheon et al., Journal of Membrane Science, 284 (2006) 237-247; and McCutcheon et al., Journal of Membrane Science, 318 (2008) 458-466). Nevertheless, it was reported that the cellulose triacetate, the membrane material of HTI FO membrane was not stable in alkaline solutions and would degrade at pH 9 (see Miller et al., Forward Osmosis: A New Approach to Water Purification and Desalination. 2006, Sandia National Laboratories).

In contrast, the dual-layer hollow fiber membrane developed in this work could be operated as a forward osmosis membrane under harsh environment since both PBI and PES materials have superior chemical resistance. FIG. 5 shows that the membrane can reach almost 25 LMH water flux and 10⁵ times less of salt flux when it is operated in the PRO mode. It should be mentioned that the relatively high flux was achieved with a very low draw solution crossflow rate which the peristaltic pumps could sustain and at a non-elevated operation temperature. The water flux of this dual-layer FO membrane generally surpasses those achieved by RO membranes and is comparable or even better than most FO processes using commercial HTI FO membranes. It is expected that by tailoring dual-layer membrane structures, especially by further reducing its selective skin thickness and optimizing hydrodynamic flow conditions in FO process, the water flux can further be enhanced.

### Example 4

### Protein Enrichment with the Aid of PBI-PES-PVP Dual-Layer Hollow Fiber Forward Osmosis Membrane

Lysozyme, an important protein enzyme with a pI value around 11 and maximum enzymatic activity at pH 4-6 (see Bonincontro et al., Colloids and Surfaces B-Biointerfaces, 12 (1998) 1-5), was chosen as a typical pharmaceutical dilute solution for the enrichment test.

It is well known that the existence of an amphoteric imidazole group within PBI molecules provides the PBI membranes with different charge signs based on pH values of the aqueous media. In general the PBI membrane is positively charged at lower pH and negatively charged at higher pH. Therefore, in the lysozyme enrichment experiment, the feed protein solution was purposely flowed against the PBI selective outer-layer. The feed native protein solution at pH ˜4 provided both PBI selective skin and lysozyme positive charges. Therefore, the lysozyme rejection by the dual-layer membrane could be achieved by both the electrostatic repulsion and PBI sub-nano pore skin's size exclusion. This ensured that there was no or very less protein loss into the draw solution during the FO enrichment process, which was confirmed with the fact that no lysozyme was detected by the UV-Vis spectrophotometer in the draw solution over the expanded experimental time.

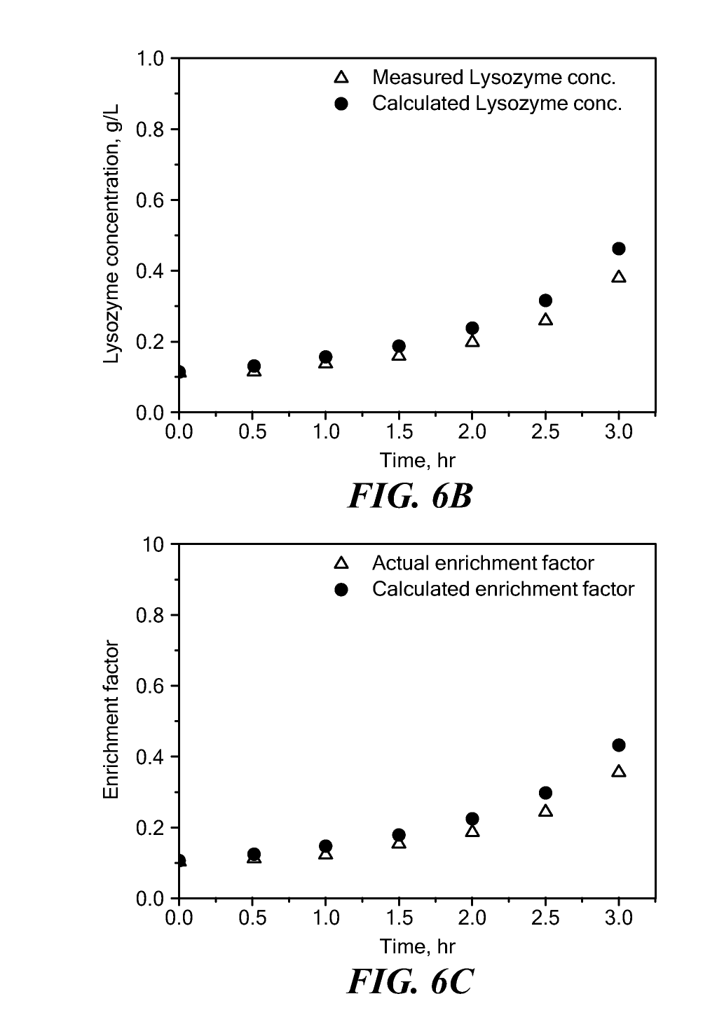

In FIG. 6(A), the slope of feed weight change decreases slightly with time. It was caused by the decreased osmotic pressure across the membrane since the original 3.125 M MgCl₂ draw solution was diluted with time when water permeated from the feed protein solution to the draw solution. The initial water flux in protein enrichment test was 12.8 LMH, which was lower than 13.7 LMH obtained in water reclamation test in FO mode using correspondingly same draw solution concentration. This was due to the lower effective driving force across the membrane in protein enrichment test since the protein solution itself had an osmotic pressure. In addition, it was found that the calculated feed lysozyme concentration based on the mass balance was slightly higher than the measured one, especially at late stage of the enrichment test as demonstrated by FIG. 6(B). It is hypothesized that the hydrophilic PBI outer-layer with a contact angle less than 60° shown in Table IV is mostly contributed to the less fouling occurred in the first one and half hour. However, the slow crossflow rate of the feed protein in the membrane's shell side still leads the occurrence of fouling. FIG. 6(C) shows the lysozyme dilute solution can be enriched by a factor of 3.5 after 3 hours. The enrichment factor is defined as the protein concentration at time t over the initial feed protein concentration.

TABLE IV
Contact angle measurements on PBI-PES dual-layer hollow fiber
membranes

| | PBI outer-layer | PES inner-layer |
|---|---|---|
| Hollow fiber membrane | 54.2 ± 0.9 | — |
| by tensiometry (°) | | |
| Flat membrane by | 57.3 ± 1.3 | 73.5 ± 2.7 |
| goniometry (°) | | |

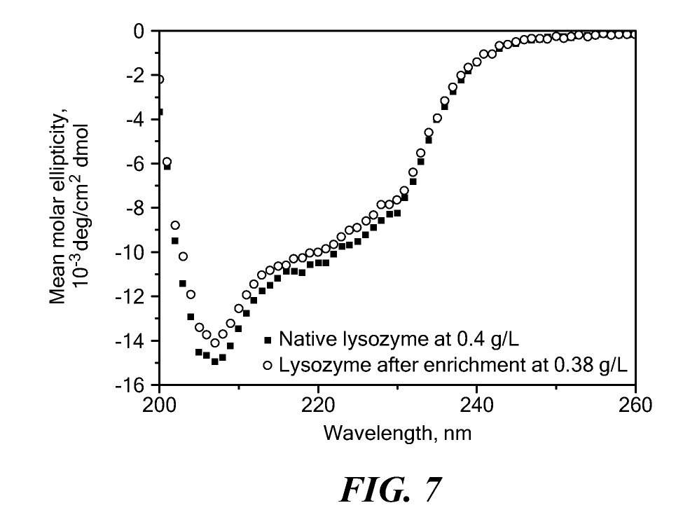

The salt flux during the protein enrichment test was satisfactorily low at 1.73 gMH. FIG. 7 shows the CD spectra of lysozyme after the enrichment test was very close to the native protein. This indicates the lysozyme after test kept most of its original structure. In addition, table inset in FIG. 7 demonstrates the helix content of the lysozyme after test was very close to the literature value of 32% (Norde et al., Colloids and Surfaces, 64 (1992) 87-93). All these demonstrate that the FO process is very promising for pharmaceutical product enrichment via dewatering without denaturing the components of interest.

### Other Embodiments

All of the features disclosed in this specification may be combined in any combination. Each feature disclosed in this specification may be replaced by an alternative feature serving the same, equivalent, or similar purpose. For example, the membranes of this invention can be applied for gas separation. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the scope of the following claims.

What is claimed is:

1. A hollow fiber comprising:
a lumen,
a polymeric membrane defining the lumen, and
a porous tubular substrate, a circumferential surface of which is in contact with a circumferential surface of the polymeric membrane,
wherein the polymeric membrane includes a first polymer having monomers each containing an imidazole group.

2. The hollow fiber of claim 1, wherein the outer circumferential surface of the substrate is in contact with the inner circumferential surface of the polymeric membrane.

3. The hollow fiber of claim 1, wherein the first polymer has bicyclic- or tri-cyclic heteroaryl monomers each containing an imidazole group.

4. The hollow fiber of claim 1, wherein the first polymer is a polybenzimidazole.

5. The polymeric membrane of claim 4, wherein the polybenzimidazole is poly-2,2′-(m-phenylene)-5,5′-bibenzimidazole, poly-2,2′-(pyridylene-3″,5″)-5,5′-bibenzimidazole, poly-2,2′-(furylene-2″,5″)-5,5′-bibenzimidazole, poly-2,2-(naphthalene-1″,6″)-5,5′-bibenzimidazole, poly-2,2′-(biphenylene-4″,4″)-5,5′-bibenzimidazole, poly-2,2′-amylene-5,5′-bibenzimidazole, poly-2,2′-octamethylene-5,5′-bibenzimidazole, poly-2,6-(m-phenylene)-diimidazobenzene, poly-2,2′-cyclohexenyl-5,5′-bibenzimidazole, poly-2,2′-(m-phenylene)-5,5′ di(benzimidazole)ether, poly-2,2′-(m-phenylene)-5,5′-di(benzimidazole)sulfide, poly-2,2′-(m-phenylene)-5,5′-di(benzimidazole)sulfone, poly-2,2′-(m-phenylene)-5,5′-di(benzimidazole)methane, poly-2′-2″-(m-phenylene)-5′,5″-(di(benzimidazole)propane-2,2, or poly-2′,2″-(m-phenylene)-5′,5″-di(benzimidazole)ethylene-1,2.

6. The polymeric membrane of claim 4, wherein the polybenzimidazole is poly-2,2′-(m-phenylene)-5,5′-bibenzimidazole.

7. The hollow fiber of claim 4, wherein the substrate includes a second polymer selected from the group consisting of polysulfone, a polyethersulfone, a polyarylate, a polyacrylnitrile, a polysulfide, a polyvinyl alcohol, a polyketone, a polyetherketone, a polyamide-imide, a polyimide, a polyamide, and a combination thereof.

8. The hollow fiber of claim 7, wherein the substrate further includes a polyvinylpyrrolidone blended with the second polymer.

9. The hollow fiber of claim 8, wherein the polyvinylpyrrolidone has a molecular weight of 80-500 KDa.

10. The hollow fiber of claim 8, wherein the second polymer is a polyethersulfone.

11. The hollow fiber of claim 1, wherein the polymeric membrane has a thickness between 1 μm and 100 μm.

12. The hollow fiber of claim 1, wherein the hollow fiber has a thickness between 100 μm and 1000 μm.

13. The hollow fiber of claim 1, wherein the first polymer is the only polymer contained in the polymeric membrane.

14. A hollow fiber prepared by a method comprising:
providing a first solution including a first solvent and a first polymer having monomers each containing an imidazole group,
providing a second solution including a second solvent and a second polymer, and
co-extruding the first and second solutions through a spinneret having at least two coaxial channels into a coagulation bath, thereby forming the hollow fiber having a lumen, a first tubular layer defining the lumen, and a second tubular layer, a circumferential surface of which is in contact with a circumferential surface of the first tubular layer,
wherein the first tubular layer contains the first polymer and the second tubular layer contains the second polymer and is porous.

15. The polymeric membrane of claim 14, wherein the first polymer is a polybenzimidazole.

16. The polymeric membrane of claim 15, wherein the polybenzimidazole is poly-2,2′-(m-phenylene)-5,5′-bibenzimidazole.

17. The hollow fiber of claim 14, wherein the second polymer is polysulfone, a polyethersulfone, a polyarylate, a polyacrylnitrile, a polysulfide, a polyvinyl alcohol, a polyketone, a polyetherketone, a polyamide-imide, a polyimide, a polyamide, or a combination thereof.

18. The hollow fiber of claim 14, wherein the second solution further includes a polyvinylpyrrolidone.

19. The hollow fiber of claim 14, wherein the first polymer is the only polymer contained in the first tubular layer.

20. The hollow fiber of claim 14, wherein the co-extruding is performed at a temperature between 20° C. and 100° C.

21. The hollow fiber of claim 14, wherein the co-extruding is performed at a temperature between 20° C. and 50° C.

22. The hollow fiber of claim 14, wherein the coagulation bath has a temperature between 0° C. and 100° C.

23. The hollow fiber of claim 14, wherein the coagulation bath has a temperature between 20° C. and 50° C.

24. The hollow fiber of claim 14, wherein the coagulation bath and the spinneret have an air gap between 0.5 cm and 100 cm.

25. The hollow fiber of claim 14, wherein the coagulation bath and the spinneret have an air gap between 1 cm and 20 cm.

26. A method for extracting water from a saline solution through a forward osmosis process, the method comprising:
contacting a first saline solution with the inner circumferential surface of the hollow fiber of claim 1 and
contacting a second saline solution with the outer circumferential surface of the hollow fiber to allow one of the first and second saline solutions to extract water from the other through a forward osmosis process,
wherein the first and second saline solutions are separated by the hollow fiber, the first saline solution has a first water content, and the second saline solution has a second water content different from the first water content.

27. A method for extracting water from a saline solution through a forward osmosis process, the method comprising:
contacting a first saline solution with the inner circumferential surface of the hollow fiber of claim 14 and
contacting a second saline solution with the outer circumferential surface of the hollow fiber to allow one of the first and second saline solutions to extract water from the other through a forward osmosis process,
wherein the first and second saline solutions are separated by the hollow fiber, the first saline solution has a first water content, and the second saline solution has a second water content different from the first water content.

28. A method for enriching a protein in an aqueous solution through a forward osmosis process, the method comprising:
contacting a first aqueous solution with the inner circumferential surface of the hollow fiber of claim 1 and
contacting a second aqueous solution with the outer circumferential surface of the hollow fiber to allow one of the first and second aqueous solutions to extract water from the other through a forward osmosis process,
wherein the first and second aqueous solutions, one containing the protein and having a lower osmotic pressure than the other, are separated by the hollow fiber.

29. A method for enriching a protein in an aqueous solution through a forward osmosis process, the method comprising:
contacting a first aqueous solution with the inner circumferential surface of the hollow fiber of claim 14 and
contacting a second aqueous solution with the outer circumferential surface of the hollow fiber to allow one of the first and second aqueous solutions to extract water from the other through a forward osmosis process,
wherein the first and second aqueous solutions, one containing the protein and having a lower osmotic pressure than the other, are separated by the hollow fiber.
